(19) United States
(12) Patent Application Publication
(10) Pub. No.: US 2006/0221278 A1
(43) Pub. Date: Oct. 5, 2006

(54) Liquid crystal display

(75) Inventors: Yi-Chun Wu, Hualien County (TW); Wen-Jui Liao, Taichung County (TW)

Correspondence Address: BACON & THOMAS, PLLC, 625 SLATERS LANE, FOURTH FLOOR, ALEXANDRIA, VA, 22314, US

(73) Assignee: Wintek Corporation, TAICHUNG (TW)

(21) Appl. No.: 11/393,777

(22) Filed: Mar. 31, 2006

(30) Foreign Application Priority Data
Apr. 5, 2005 (JP) 2005-109010

(51) Int. Cl. G02F 1/1335

(52) U.S. Cl. 349/114

(57) ABSTRACT

A liquid crystal display includes a liquid crystal polymer film located under a liquid crystal layer. The liquid crystal film has a retardation substantially equal to that of the liquid crystal layer, a twist angle substantially equal to that of the liquid crystal cell, and a twist aspect opposite to that of the liquid crystal layer. As a result, the liquid crystal display has a high contrast ratio.

### BACKGROUND OF THE INVENTION

1. Field of the Invention p The present invention relates generally to a liquid crystal display (LCD), and more particularly to a transflective LCD having a high contrast ratio.

2. Description of the Related Art

Liquid crystal has both properties of optical rotary power and birefringence, so that when light passes through the liquid crystal layer of an LCD the optical interference phenomenon is occurred because the light splits with individually retarded phases. It is difficult to have a full-colored performance for the LCD due to such interference phenomenon.

There are many approaches applied in the conventional transflective LCDs to enhance the contrast ratio of the displays by means of improving the disadvantage effects resulted from the retardation due to the birefringence property of the liquid crystal. For example, FIG. 1 shows a conventional LCD 10 comprising two liquid crystal cells (LC cells) 13, 14 sandwiched between a pair of polarizers 11, 12. The LC cells 13, 14 have substantially the same retardation but opposite twist aspect with respect to each other. The LCD 10 has a high contrast ratio in transmissive mode when a backlight unit 15 incidents light into the LC cells 13, 14 since the equivalent transmitted phase difference approaches to zero because of the offset of the opposite retarded phases. However, the stacked LC cells cause the LCD 10 not only thicker thickness but also higher manufacturing cost.

As shown in FIG. 2, another conventional LCD 20 is provided. By means of an LC cell 21 having the same optical path difference in transmissive region and reflective region, the LCD 20 has the comparable contrast ratio in both of the transmissive mode and the reflective mode. For this purpose, a reflective film 22 formed in the LC cell 21 must be elevated to a height (½ d), which is a half of the cell gap of the transmissive region (d) in the reflective region. Under this circumstance, the reflective film 22 must be supported on an additional spacer 24 that is bonded on a substrate 23. However, this increase the manufacturing cost of the LCD 20.

FIG. 3 shows still another conventional LCD 30. An LC cell 32 is sandwiched between a pair of polycarbonate retardation films 34, 35 followed by two polarizers 31, 33 respectively. The retardation films 34, 35 are used as compensators for the retardation of the liquid crystal of the LC cell 32. While the polycarbonate retardation films 34, 35 compensate effectively for the transmissive mode, it sacrifices the contrast ratio of the reflective mode, and vice versa. In other words, the use of compensators cannot provide an acceptable contrast ratio satisfied both by the transmissive mode and the reflective mode.

### SUMMARY OF THE INVENTION

The primary objective of the present invention is to provide a liquid crystal display having a high contrast ratio.

The secondary objective of the present invention is to provide a liquid crystal display having a high contrast ratio in both transmissive mode and reflective mode.

The third objective of the present invention is to provide a liquid crystal display which is simplified in fabrication and is less in manufacturing cost.

According to the objectives of the present invention, a liquid crystal display provided by the present invention comprises an upper polarizer, a lower polarizer, an upper substrate, a lower substrate, a liquid crystal layer located between the upper and lower substrates, a liquid crystal film located selectively between the liquid crystal layer and the lower substrate or between the lower substrate and the lower polarizer, and a backlight unit located below the lower polarizer.

### BRIEF DESCRIPTION OF THE DRAWINGS

FIG. 1 is a schematic sectional view of a conventional LCD according to prior art;

FIG. 2 is a schematic sectional view of another conventional LCD according to prior art;

FIG. 3 is a schematic sectional view of still another conventional LCD according to prior art;

FIG. 4 is a schematic sectional view of a first preferred embodiment of the present invention;

FIG. 5 shows a correlation curve between the reflection rate and applied voltage under the normally black mode of the first preferred embodiment of the present invention;

FIG. 6 shows a correlative curve between the transmission rate and applied voltage under the normally black mode of the first preferred embodiment of the present invention;

FIG. 7 is a schematic sectional view of an alternative form of the first preferred embodiment of the present invention, showing a color filter is additionally applied;

FIG. 8 is a schematic sectional view of a second preferred embodiment of the present invention;

FIG. 9 is a schematic sectional view showing the upper polarizer set between the upper substrate and the upper electrode;

FIG. 10 is a schematic sectional view showing the upper polarizer set between the alignment film and the upper electrode;

FIG. 11 is a schematic sectional view showing the liquid crystal film set between the transflective film and the lower polarizer;

FIG. 12 is a schematic sectional view showing that the liquid crystal film is set between the transflective film and the lower polarizer and the upper polarizer is set between the upper substrate and the upper electrode;

FIG. 13 is a schematic sectional view showing that the liquid crystal film is set between the transflective film and the lower polarizer and the upper polarizer is set between the alignment film and the upper electrode; and

FIG. 14 is a schematic sectional view showing the LCD in the normally white mode.

### DETAILED DESCRIPTION OF THE INVENTION

As shown in FIG. 4, a transflective liquid crystal display 50 of the first preferred embodiment of the present invention applied in a normally black mode mainly comprises an upper polarizer 51, a lower polarizer 52, a liquid crystal cell (LC cell) 53, a liquid crystal film (LC film) 54 and a backlight unit 55. The backlight unit 55 is arranged under the lower polarizer 52.

The LC cell 53 is arranged between the upper and lower polarizers 51 and 52 and includes an upper substrate 531, an upper electrode 532, an alignment film 533, a liquid crystal layer 534, an alignment film 535, a lower electrode 536, a transflective film 537 and a lower substrate 538 in sequence. In the present preferred embodiment, the LC mode for the LC cell 53 is the MTN (Mixed-mode Twisted Nematic) mode having a relatively higher contrast ratio and reflection rate. The liquid crystal molecules of the LC cell 53 have a left-handed twist angle of about 70 degrees and a retardation value difference of 0.26 μm.

The LC film 54, which is arranged between the lower substrate 538 and the lower polarizer 52, is made by liquid crystal polymer. The difference of retardation value between the LC film 54 and the LC cell 53 is within 0.02 μm, and the difference of twist angle between the LC film 54 and the LC cell 53 is within 10 degrees. Preferably, the twist angle of the LC film 54 is equal to that of the LC cell 53 and the twist aspect of the LC film 54 is opposite to that of the LC cell 53, that is, the LC film 54 has preferably a right-handed twist angle of about 70 degrees.

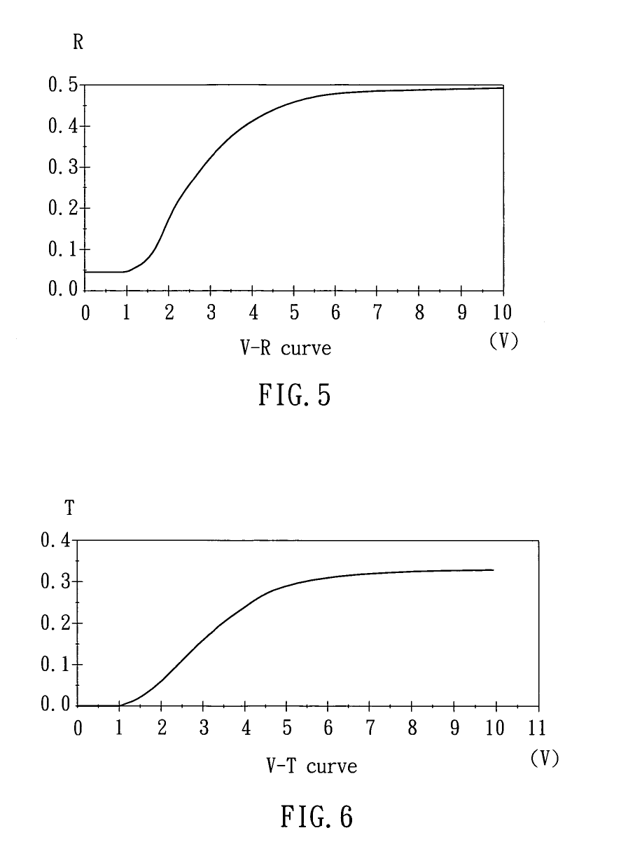

FIG. 5 is a correlation curve between the reflection rate and applied voltage (V-R curve) under the normally black mode of the LCD 50 of the present invention. Such correlation indicates that the value of the contrast ratio (brightness/darkness) is greater than 15 under reflective mode, as a result, the LCD 50 under reflective mode can gain better contrast ratio and reflection rate.

FIG. 6 is a correlation curve between the transmission rate and applied voltage (V-T curve) under the normally black mode of the LCD 50 of the present invention. The much higher contrast ratio (brightness/darkness) shown in FIG. 6 under transmissive mode proves that the LCD 50 of the present invention has an excellent contrast ration in transmissive mode.

Consequently, the present invention provides the LC film 54 to compensate the retardation of the liquid crystal layer 534 induced by the birefringence property. When in the transmissive mode, the retardation of light that passes through the LC film 54 and the liquid crystal layer 534 is almost zero. The LCD 50 of the present invention keeps the high contrast ratio and reflection rate in the reflective mode too. As a result, the LCD 50 of the present invention has a high contrastable display.

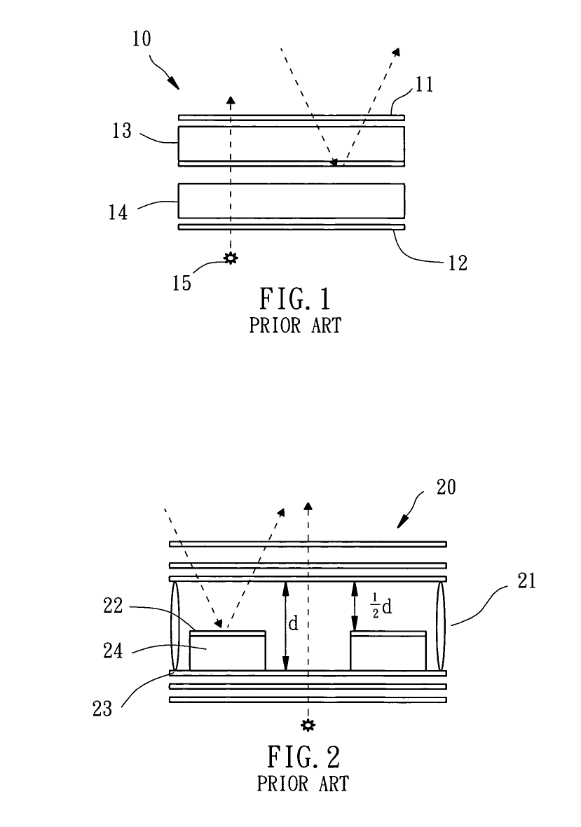

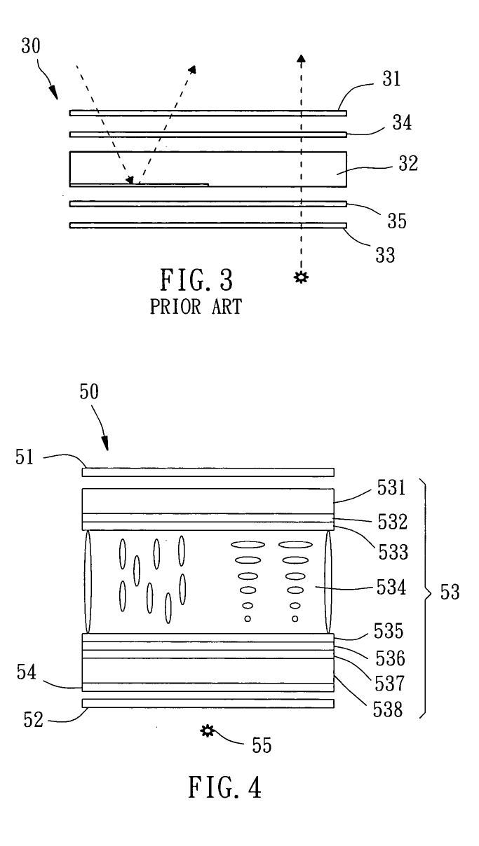

Practically, the LCD 50 of the present invention has neither the disadvantages of the conventional LCD, as shown in FIG. 1, which has a thicker thickness and higher manufacturing cost due to the use of double LC cells nor the disadvantage of the conventional LCD, as shown in FIG. 2, which is difficult in manufacturing due to the dual gap structure in the LC cell.

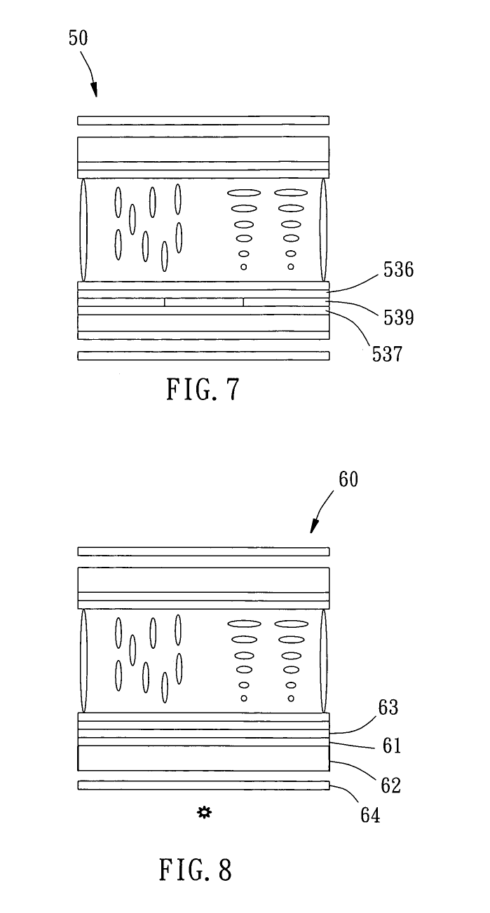

As shown in FIG. 7, the LCD 50 of the present invention further provides a color filter film 539 set between the lower electrode 536 and the transflective film 537 so as to obtain a full-colored LCD.

As shown in FIG. 8, a transflective LCD 60 provided by the second preferred embodiment of the present invention under the normally black mode is structurally similarly to the LCD 50 of the first preferred embodiment, except that the LC film 61 of the LCD 60 is set between a lower substrate 62 and a transflective film 63, and a lower polarizer 64 is at the bottom thereof still. The LCD 60 of the second preferred embodiment of the present invention serves the same function as discussed above.

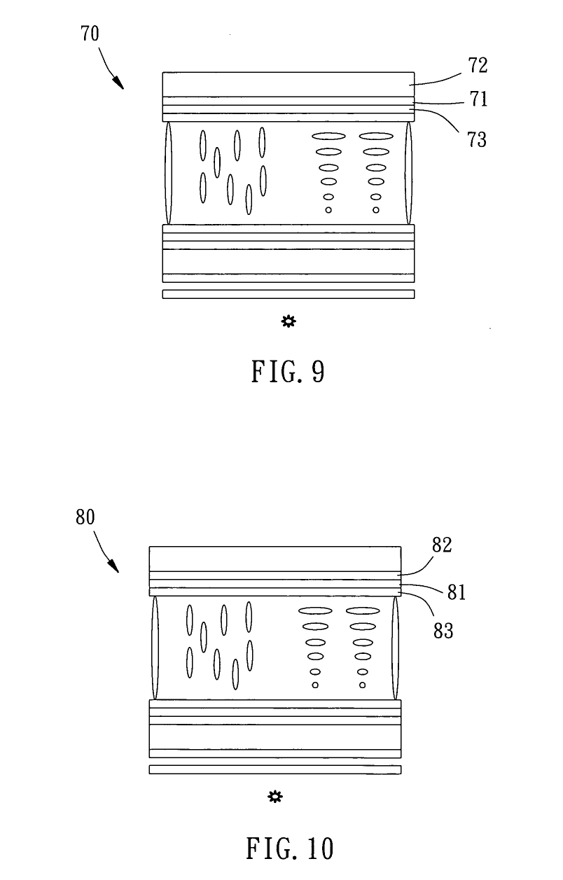

It has to be mentioned that the location of either the upper polarizer or the lower polarizer is not limited to the position shown in FIGS. 4, 7 and 8. For example, as shown in FIG. 9, the upper polarizer 71 of the LCD 70 is arranged between the upper substrate 72 and the upper electrode 73. As shown in FIG. 10, the upper polarizer 81 of the LCD 80 is arranged between the upper electrode 82 and the alignment film 83.

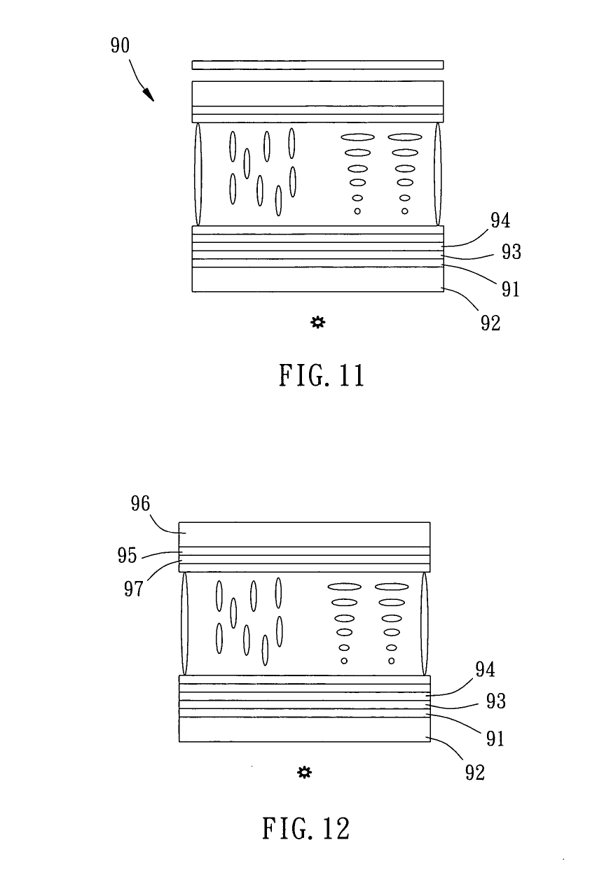

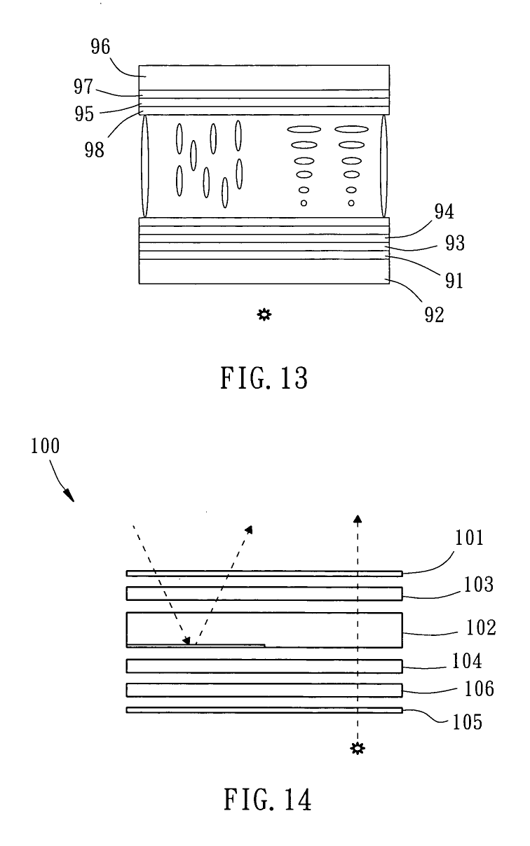

FIG. 11 shows an LCD 90 provided by another preferred embodiment of the present invention. The LCD 90 is structurally similar to the LCD 60 shown in FIG. 8, except that the LCD 90 has the lower polarizer 91 arranged between the lower substrate 92 and the LC film 93. In other words, the LC film 93 of the LCD 90 is arranged between the lower polarizer 91 and the transflective film 94. Based on the aforesaid arrangement of the lower polarizer 91 as shown in FIG. 11, the upper polarizer 95 can also be arranged between the upper substrate 96 and the upper electrode 97 as shown in FIG. 12, or between the upper electrode 97 and the alignment film 98 as shown in FIG. 13.

It is to be mentioned that in stead of the MTN mode, the LC mode for the transflective LCD of the present invention can be the STN (Super Twisted Nematic) mode, which has a twist angle ranging from 180 degrees to 210 degrees and a retardation ranging from 0.58 μm to 0.66 μm.

The LCD of the present invention may be further provided with a quarter wavelength plate to change the normally black mode into a normally white mode. As shown in FIG. 14, an LCD 100 is provided with a first quarter wavelength plate 103 set between an upper polarizer 101 and an LC cell 102, and a second quarter wavelength plate 106 set between an LC film 104 and a lower polarizer 105. Without applied voltage, the LCD 100 has a white display, which is so-called the normally white mode, with a high contrast ratio. For the further application, the LCD 100 may be provided with two half wavelength plates to work with the first and second quarter wavelength plates 103 and 106, or the LCD 100 may be provided with two wide-band quarter wavelength plates to individually replace the first and second quarter wavelength plates 103 and 106.

While the invention has been described by way of examples and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A liquid crystal display, comprising:
an upper polarizer;
a lower polarizer;
a liquid crystal cell located between the upper polarizer and the lower polarizer;
a liquid crystal film located between the liquid crystal cell and the lower polarizer; and
a backlight unit located below the lower polarizer;
wherein the liquid crystal cell comprises an upper substrate, a lower substrate, a liquid crystal layer located between the upper substrate and the lower substrate, and a transflective film located between the lower substrate and the liquid crystal layer;
wherein the liquid crystal film has a retardation substantially equal to that of the liquid crystal cell, a twist angle substantially equal to that of the liquid crystal cell, and a twist aspect opposite to that of the liquid crystal cell.

2. The liquid crystal display as defined in claim 1, further comprising a color filter film located between the liquid crystal layer and the transflective film.

3. The liquid crystal display as defined in claim 1, wherein a difference of retardation between the liquid crystal film and the liquid crystal cell is within 0.02 μm, and a difference of twist angle between the liquid crystal film and the liquid crystal cell is within 10 degrees.

4. The liquid crystal display as defined in claim 1, wherein the liquid crystal film is made of a liquid crystal polymer material.

5. The liquid crystal display as defined in claim 1, wherein the liquid crystal cell has a liquid crystal mode of mixed-mode twisted nematic.

6. The liquid crystal display as defined in claim 1, wherein the liquid crystal cell has a liquid crystal mode of super twisted nematic.

7. The liquid crystal display as defined in claim 1, further comprising a first quarter wavelength plate located between the upper polarizer and the liquid crystal cell and a second quarter wavelength plate located between the liquid crystal film and the lower polarizer.

8. A liquid crystal display, comprising:
an upper substrate;
a lower substrate;
a liquid crystal layer located between the upper substrate and the lower substrate;
a liquid crystal film located between the liquid crystal layer and the lower substrate;
a transflective film located between the liquid crystal layer and the liquid crystal film;
a lower polarizer located at an outer side of the lower substrate; and
a backlight unit located below the lower substrate;
wherein the liquid crystal film has a retardation substantially equal to that of the liquid crystal layer, a twist angle substantially equal to that of the liquid crystal layer, and a twist aspect opposite to that of the liquid crystal layer.

9. The liquid crystal display as defined in claim 8, wherein the liquid crystal film is made of a liquid crystal polymer material.

10. The liquid crystal display as defined in claim 8, wherein a difference of retardation between the liquid crystal film and the liquid crystal layer is within 0.02 μm, and a difference of twist angle between the liquid crystal film and the liquid crystal layer is within 10 degrees.

11. The liquid crystal display as defined in claim 8, wherein the liquid crystal layer has a liquid crystal mode of mixed-mode twisted nematic.

12. The liquid crystal display as defined in claim 8, wherein the liquid crystal layer has liquid crystal mode of super twisted nematic.

13. The liquid crystal display as defined in claim 8, further comprising a color filter film located between the liquid crystal layer and the transflective film.

14. The liquid crystal display as defined in claim 8, further comprising an upper polarizer located at an outer side of the upper substrate.

15. The liquid crystal display as defined in claim 8, further comprising an upper polarizer located between the upper substrate and the liquid crystal layer.

16. The liquid crystal display as defined in claim 14, further comprising a first quarter wavelength plate located between the upper polarizer and upper substrate and a second quarter wavelength plate located between the liquid crystal film and the lower polarizer.

17. The liquid crystal display as defined in claim 15, further comprising a first quarter wavelength plate located between the upper polarizer and liquid crystal layer and a second quarter wavelength plate located between the liquid crystal film and the lower polarizer.

18. A liquid crystal display, comprising:
an upper substrate;
a lower substrate;
a liquid crystal layer located between the upper substrate and the lower substrate;
a liquid crystal film located between the liquid crystal layer and the lower substrate;
a transflective film located between the liquid crystal layer and the liquid crystal film;
a lower polarizer located between the liquid crystal film and the lower substrate; and
a backlight unit located below the lower substrate;
wherein the liquid crystal film has a retardation substantially equal to that of the liquid crystal layer, a twist angle substantially equal to that of the liquid crystal layer, and a twist aspect opposite to that of the liquid crystal layer.

19. The liquid crystal display as defined in claim 18, wherein a difference of retardation between the liquid crystal film and the liquid crystal layer is within 0.02 μm, and a difference of twist angle between the liquid crystal film and the liquid crystal layer is within 10 degrees.

20. The liquid crystal display as defined in claim 18, wherein the liquid crystal film is made of a liquid crystal polymer material.

21. The liquid crystal display as defined in claim 18, further comprising a color filter film located between the liquid crystal layer and the transflective film.

22. The liquid crystal display as defined in claim 18, further comprising an upper polarizer located at an outer side of the upper substrate.

23. The liquid crystal display as defined in claim 18, further comprising an upper polarizer located between the upper substrate and the liquid crystal layer.

24. The liquid crystal display as defined in claim 22, further comprising a first quarter wavelength plate located between the upper polarizer and upper substrate and a second quarter wavelength plate located between the liquid crystal film and the lower polarizer.

25. The liquid crystal display as defined in claim 23, further comprising a first quarter wavelength plate located between the upper polarizer and liquid crystal layer and a second quarter wavelength plate located between the liquid crystal film and the lower polarizer.
